(19) United States
(12) Patent Application Publication
(10) Pub. No.: US 2003/0036968 A1
(43) Pub. Date: Feb. 20, 2003

(54) Process & transformation private exchange

(76) Inventor: Norman Ken Ouchi, San Jose, CA (US)

Correspondence Address: NORMAN KEN OUCHI, 20248 VIEW CREST CT, SAN JOSE, CA, 95120, US

(21) Appl. No.: 09/933,209

(22) Filed: Aug. 20, 2001

(51) Int. Cl. G06F 17/60

(52) U.S. Cl. 705/26

(57) ABSTRACT

This invention is related to electronic information transfer between trading partners and more particularly to the processing and distribution of information in a variety of transformable formats.

In the present invention, a process and transformation private exchange includes a process description, a sequence of process nodes, where the process and transformation private exchange receives information in a first format, executes a process node that translates information in a first format into a standard format, a second process node translates the information in standard format into a second format, and a third process node to send the information in the second format. The process description may include process nodes that operate on the information in the standard format.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF THE INVENTION

This invention is related to electronic information transfer between trading partners and more particularly to the processing and distribution of information in a variety of transformable formats.

### BRIEF SUMMARY OF THE INVENTION

In the present invention, a process and transformation private exchange includes a process description, a sequence of process nodes, where the process and transformation private exchange receives information in a first format, executes a process node that translates information in a first format into a standard format, a second process node translates the information in standard format into a second format, and a third process node to send the information in the second format. The process description may include process nodes that operate on the information in the standard format.

### BACKGROUND OF THE INVENTION

The electronics industry has been dramatically transformed with the rise of the contract manufacturing sector called Electronic Manufacturing Service or EMS where most traditional electronics companies, called Original Equipment Manufacturers or OEM, have shed their manufacturing facilities and depend to a large extent on the EMS. The EMS have developed significant capabilities well beyond traditional manufacturing and can establish and manage supply chains for their OEM customers, provide repair and refurbish function for the OEM and perform contract design services for the OEM. All of these services are performed on behalf of the OEM and the customers of the OEM may not be aware these functions are in fact provided by the EMS. If an OEM has its own manufacturing facilities, it has the worst of all worlds: for successful products, the capacity is limited to the internal capacity thus creating a market for the competitors; for the failing products, the capacity is not used and the fixed cost is a drag to the bottom line. If the OEM product requires highly specialized manufacturing equipment, it may have little choice other than owning its own manufacturing facilities. The electronics industry can be characterized by the use of common manufacturing equipment where the intellectual contributions of the OEM are in the form of the specific designs and not the manufacturing processes or equipment. The EMS provides the manufacturing facilities which when given the appropriate product description from the OEM, can manufacture the OEM product. The EMS establishes a set of OEM customers and balances their product volume demands to keep the EMS facilities running at economic capacity. The OEM sheds the fixed cost of the manufacturing facility and gains a high degree of flexibility in an alliance with one or more global EMS companies where the OEM's products can be ramped quickly using the global EMS manufacturing facilities and, thus, the manufacturing cost is a variable cost based on use. Both the EMS and OEM companies gain benefits and both have had significant growth as this business model has proven to be highly successful for the electronics industry.

However, there are many difficulties. Many of the key processes that were once internal to the OEM must now be integrated with the processes of the EMS. Many of these processes require the participation of the suppliers of the OEM that are now suppliers of the EMS, the proxy of the OEM. There are three major classes of EMS processes: 1) the product description, the “what” to build, 2) the product demand/supply planning, the “how many and when” to build, and 3) the product build, the “make”. The OEM and suppliers have similar internal processes.

The EMS “what” processes uses the product description, usually from the OEM, in the form of Computer Aided Design, CAD, models or drawings; Bills of Materials, BoM, parts lists; Approved Manufacturer List, AML, purchase part list; assembly instructions and drawings, and similar descriptive data files. The CAD, BoM, AML, and other similar data files identify the parts using a set of part numbers. A set of part numbers is consistent for an organization (an OEM design group, an EMS site, a suppler) but independent of other organizations. Translation and validation of part numbers as they pass from one organization to another is a significant problem. Product Document Management, PDM, systems such as Agile and Matrix One are used to manage the product description information and “what” processes. The information in the systems to support the “what” processes is used as input to the EMS systems of “how many and when” processes in the form of BoM's, AML, and identification of new parts in the BoM's. The information in the “what” process system is sent to the suppliers to specify to them “what” should be purchased as components or sub-assemblies. And the information in the “what” process system is used by the “make” process and supporting systems to define the manufacture of the product and may include the programming of automated assembly equipment.

The EMS “how many and when” processes are usually driven by forecasts and orders from the OEM for the quantity and delivery dates for units to be built. Enterprise Resource Planning, ERP, systems such as SAP, Oracle, Baan, and J. D. Edwards or Advance Planning systems such as i2, Web Plan and Manugistics are used to determine schedule and number of units to build from the OEM forecast and orders; from the Bill of Material, BoM, determine the components for each unit to be built and to calculate the quantities and delivery dates of the components to be ordered, from the Approved Manufacture List, AML, place the orders for the components from approved suppliers using the supplier part numbers to identify each ordered component, and create the shop orders with quantities and delivery dates to build the units on the shop floor.

The “make” process may use system such as Data Sweep for shop floor control, and programmed assembly machines such as those from Fuji and Panasonic for electronic printed card assembly. The EMS manufacturing processes are similar but use a wide variety of programmable equipment and systems to manufacture the products. Each type of automated equipment requires a specific type of component carrier to feed the component into the machine. Thus, a component from a supplier may have several different carrier types in which the component may be delivered by the suppler. For a given component, the supplier has a different part number for each of the different carrier types. An OEM designer may have specified a component for use in a product and provided a supplier part number to purchase the component. However, the part number to be purchased depends on the carrier type required by the specific manufacturing equipment used to build the product. Hence, the part number provided by the OEM may not be the one that should be ordered to build the product.

The information in the “what” process system is important as input to the EMS “how many and when” process systems, the EMS “make” process systems, and supplier processes and systems. The BoM and AML are key data that are transferred from the “what” process system to the “how many and when” process systems, the ERP and Advance Planning systems. The BoM and the CAD are key information that is transferred from the “what” process system to the “make” process systems, the shop floor control and programmed manufacturing assembly machines. However, the information typical for the “what” systems are in large sets called files and the file formats specific to each system. A BoM file would contain the list of items, the quantities for each item, and possibly a description for each item. However, the format of the BoM file would depend on the source of the data. The format is more than specifying the program that generated the information. For example, a BoM could be created using Microsoft Excel and saved as a file with the file extension of “.xls”. Many ERP systems can import an .xls file. However, the format specification includes the field lengths, content designations, etc. so the fact that a file is an .xls file is not sufficient to assure use. In many cases, the BoM file from the ERP system will usually be an electronic copy of the printed BoM report and have a wide variation of formats including lines of data that represent the header, footer, page numbers, etc. Since these are reports, there will be variability even if the same ERP system is used. Thus, the BoM files need translators to convert from the initial format to the format needed to input into a specific system. In FIG. 1, an EMS Site A 1 has four OEM customers: OEM A, OEM B, OEM C, OEM D and four suppliers: Supplier A, Supplier B, Supplier C, Supplier D. EMS Site A 1 would create 4 BoM translators, one for each OEM customer. EMS Site A 1 can also create 4 BoM translators, one for each supplier. However, as illustrated in FIG. 2, the EMS may have four sites: EMS Site A 1, EMS Site B 4, EMS Site C 5, EMS Site D 6. The number of point-to point connections increase significantly. The prior art suggests a topology exchange topology where each trading partner connects to the exchange. This is illustrated in FIG. 3 where the EMS has an EMS Private Exchange 30 that connects the four EMS sites, the four OEM customers and the four suppliers. The topology appears to be much simpler in that each EMS site, OEM customer, or supplier has a single connection. However, the information transferred on the connections still requires a large number of translators and validation programs equivalent to the point-to-point topology. Each EMS site may have a different ERP system and requires 4 translators for the 4 OEM customers. With four EMS sites, 16 (4×4) translators would be required. Consider the problem for an EMS with N different ERP systems and OEM customers with M different ERP BoM output formats. They would require N×M BoM format translators for the M OEM customers. When adding a customer with a new BoM format, the EMS would have to create N format translators, one for each of the N unique EMS systems. When adding an ERP system with a new format to an EMS site, M format translators need to be created, one for each OEM. The translation problem extends to all of the EMS systems that use the BoM as input. The price quotation systems, the shop-floor systems, the PDM systems, the advanced planning systems, etc. all use some version of the BoM. There is a requirement for a large number of translators. The management and updating of the translators is also a significant task. Since each of the sets of translators are managed by each EMS site and not every site does business with all M customers, the individuals involved in the translation processes do not see the total scope of the effort. However, there are a large number of people are needed to create and maintain the nearly N×M number of translators for ERP and additional translators for other systems. The first problem is the creation and management of the large number of BOM and other information translators.

The EMS may order components from the supplier using the supplier part number, the OEM part number, or the EMS part number. The supplier tailors the ordering interface to accommodate their customers and maps the part number from their customer, the EMS, to the internal supplier part number. Establishing the ordering interface is a manual trial and error process and takes time to establish and difficult to maintain. The EMS may have multiple sites, each with their own part numbering system to order parts from the suppliers. Many of the parts may have different part numbers even though the part is the same part! The multiple EMS sites and systems create a translation problem for its suppliers and because the EMS cannot identify that multiple part numbers are the same part, the EMS cannot get the economic benefit of aggregated purchasing. A consistent part number set for the EMS sites to order from a supplier is an advantage to both the EMS and the supplier. A second problem is the translation of the EMS internal part number at each EMS site to a consistent set for each supplier.

A third problem is that the information in the files are not always correct, complete, or consistent with data in other associated files or with data already in the systems into which the file is to be loaded. It is desirable to validate the data before loading into the EMS systems. If there are N EMS systems with M different input formats, the problem can be formidable. Each EMS site may have tried to solve their local problem by writing programs that check the information after translation but before loading. The problem can be reduced to N validation programs for N EMS systems that require input validation but this still requires N programs to be written and maintained. Note that the N validation programs may have varying degrees of effectiveness and may not be consistent from EMS site to EMS site. Even if all of the information were in an industry standard format such as defined by RosettaNet, (an electronic technology industry consortium) the validation problem would still remain.

A fourth problem arises when a product is transferred from one EMS site to another. The EMS has all the information necessary to manufacture the product. However, the data are now in the format of the site from which the product is to be moved and tailored for the manufacturing equipment and processes of that site. If products are to be moved from any site to any other site, then N×(N−1) additional translators must be developed. But the problem does not end with information translation; the site has tailored the information to meet the site objectives to manufacture the product. In general, the data tailoring is irreversible in that the OEM customer data have been “corrected” or changed and not recoverable. The OEM customer may not have the complete and current information since changes may have taken place since the OEM sent the information and these changes are reflected in the data kept by the EMS and not the OEM. (Since, after all, the EMS is manufacturing the product so why should the OEM keep the data current?)

The fifth problem is that most the business processes are not limited to just the transfer of a file from one system to another but are a sequence of steps where each step may involve sending a file to a system and a resulting file sent to another system. So the translation and validation may have to be done at each step in the process. These business process steps may be geographically dispersed and running 24×365 so it may be very difficult to track the step of any given business process let alone collect information of such as the average cycle time, number of business processes executed, number of steps in a process or the number of people required for execution of a business process.

The problems:

1) Development and management of a large number of translators.

2) Consolidation of the EMS part number set and translation of part numbers to the consolidated part number set.

3) Validation and correction of information to assure integrity before further processing,

4) Product transfer from OEM to EMS and between EMS sites,

5) Controlling and tracking business processes that require multiple steps and uses information in multiple formats.

There is a large hidden cost in time, people, and information accuracy in the business processes between the OEM, EMS, and suppliers because of the lack of visibility and control of these business processes. A solution to these issues can provide significant economic benefit to this industry and thus create a business opportunity to the provider of the solution to these problems.

### BRIEF DESCRIPTION OF DRAWINGS

FIG. 1 illustrates the point-to-point information interconnections between an EMS site and four OEM customers and four suppliers.

FIG. 2 illustrates the point-to-point information interconnections between four EMS sites and four OEM customers and four suppliers.

FIG. 3 illustrates an EMS private exchange that reduces the number of point-to-point connections but not the number of translations.

FIG. 4 illustrates the file transformation from an input file format from a sender to a standard format where the transformation is selected based on the sender.

FIG. 5 illustrated the file transformation from a standard format to a file format for a receiver where the transformation is selected based on the receiver.

FIG. 6 illustrates a Process & Transformation Private Exchange for an EMS that reduces the number of point-to-point information interconnections and number of transformation programs.

FIG. 7 illustrates the connection relationship between an EMS A Process & Transformation Private Exchange, EMS A, OEM customers and suppliers and the relationship between an OEM 2 Process & Transformation Private Exchange, OEM 2, EMS providers, and suppliers.

FIG. 8 illustrates the relationship for original and transformed information between an EMS A Process & Transformation Private Exchange, EMS A, an OEM 2 Process & Transformation Private Exchange, OEM 2, EMS B, and OEM

FIG. 9A illustrates a three-step business process.

FIG. 9B illustrates the flow of information between the Process & Transformation Private Exchange and the external users and systems to execute the three-step business process.

FIG. 9C illustrates the relationship between the sequential steps of the three-step business process as executed by external users and systems and the process description and the sequence of process nodes executed in the Process & Transformation Private Exchange to support the business process.

FIG. 10A illustrates an Exchange Input and an Exchange Output and the sequences of process nodes to receive, transform to a standard format, store, retrieve, transform to a second format, and send.

FIG. 10B illustrates an Exchange Input and an Exchange Output and the sequences of process nodes that include the validation of a file in standard format.

FIG. 11A illustrates an Exchange Input and an Exchange Output and sequences of process nodes that includes the translation of a file with part numbers to a standard part number set and translation of a file with part numbers to a send part number set.

FIG. 11B illustrates an Exchange Input and a sequence of process nodes that includes sending a file in standard format to a User.

FIG. 12 illustrates the server structure of a preferred embodiment of a Process & Transformation Private Exchange.

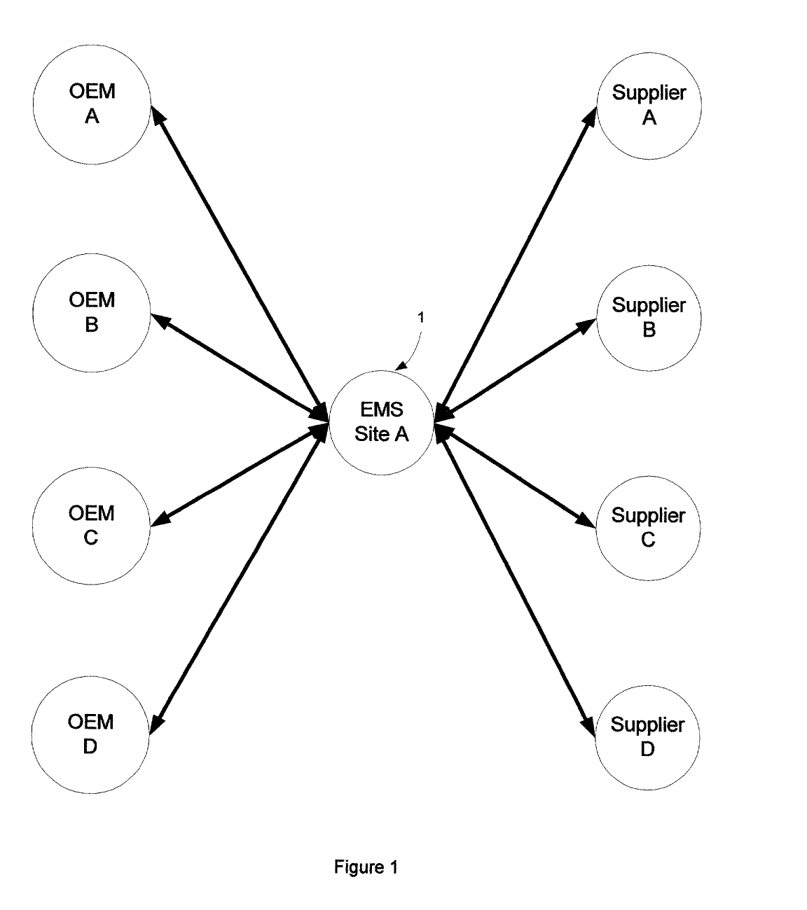

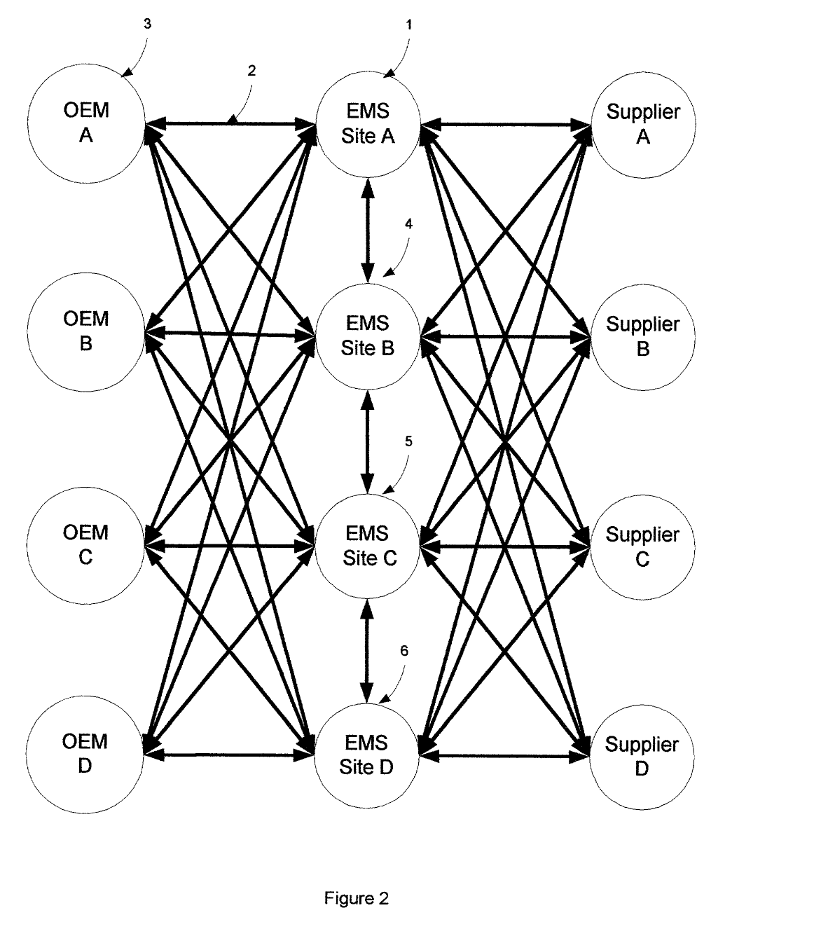

### DESCRIPTION OF THE INVENTION

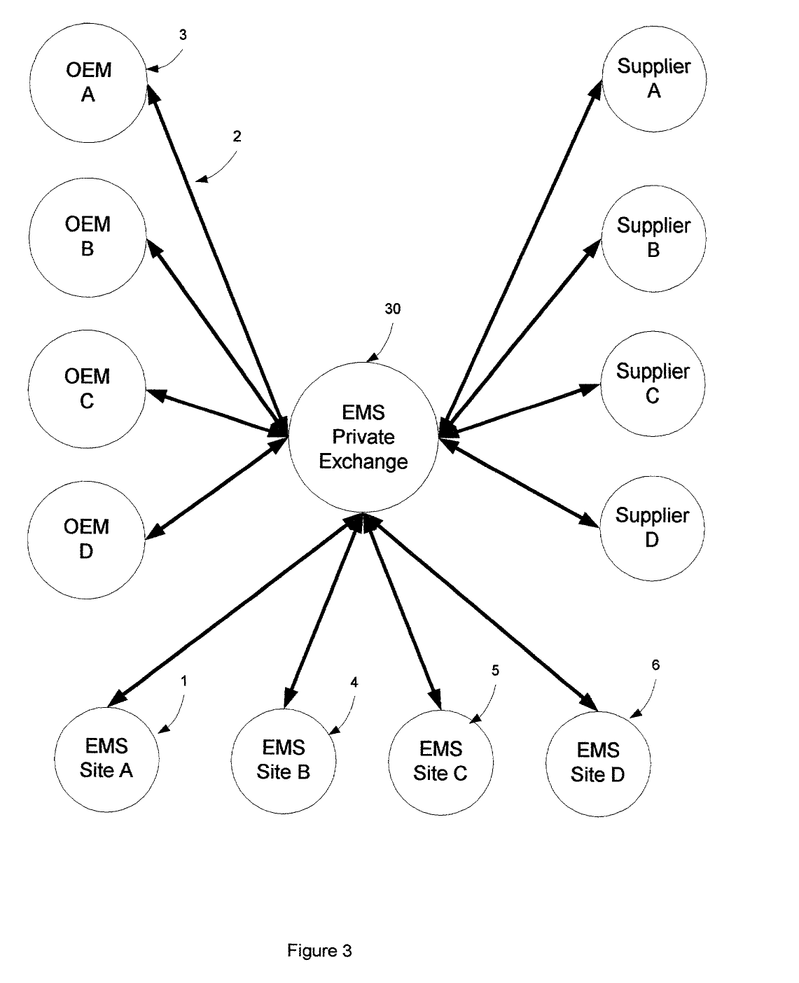

The present invention provides central exchange for electronic, formatted information transmitted between trading partners. The Process & Transformation Private Exchange transforms the incoming information from the format of a first trading partner into a standard format for validation and transformation processes, stores the standard formatted information in the exchange, transforms the information into the format of a second trading partner, and sends the information to the second trading partner. The Process & Transformation Private Exchange consists of an Exchange Input and an Exchange Output where the Exchange Input transforms the incoming information and stores the information in a standard format. The Exchange Output retrieves the information and transforms and sends it to the user. The exchange is established for a trading partner, the exchange owner, to support the interchange of information among the sites of the owner and with the customer and supplier trading partners. Since the exchange has an owner, it is called a private exchange. The standard format, validation, and transformation processes are designed to optimize the operations of the owner and may provide benefits for the other trading partners. The business processes between the private exchange participants are described as process descriptions, a sequence of process nodes, where each node performs a discrete operation. The sequence of operations accomplishes the business process. The prior art describes the private exchange topology 30 as illustrated in FIG. 3. However, the prior art does not provide for effective interchange and validation of the information passing though the private exchange. The present invention provides mechanisms to make the private exchange topology effective.

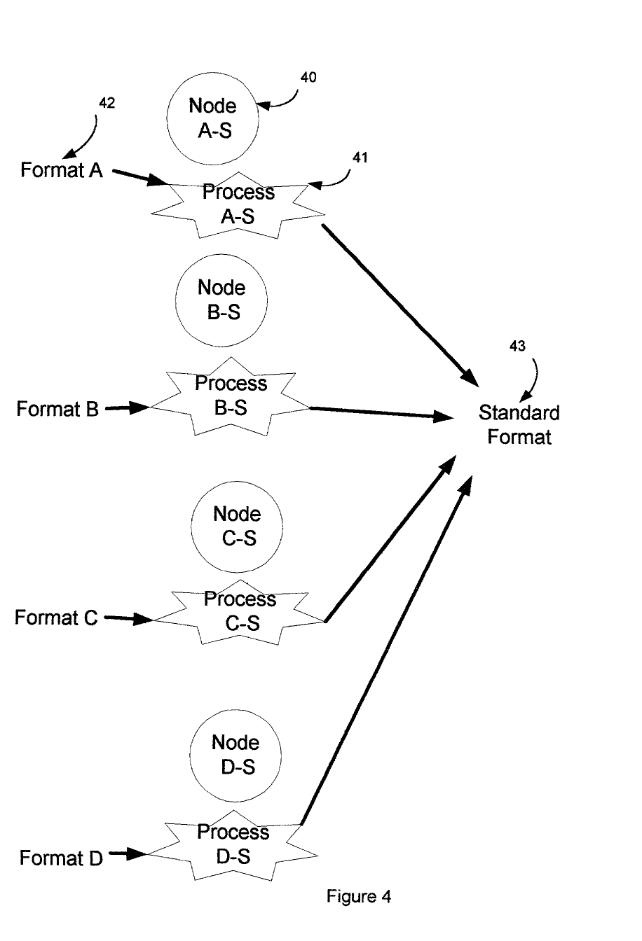

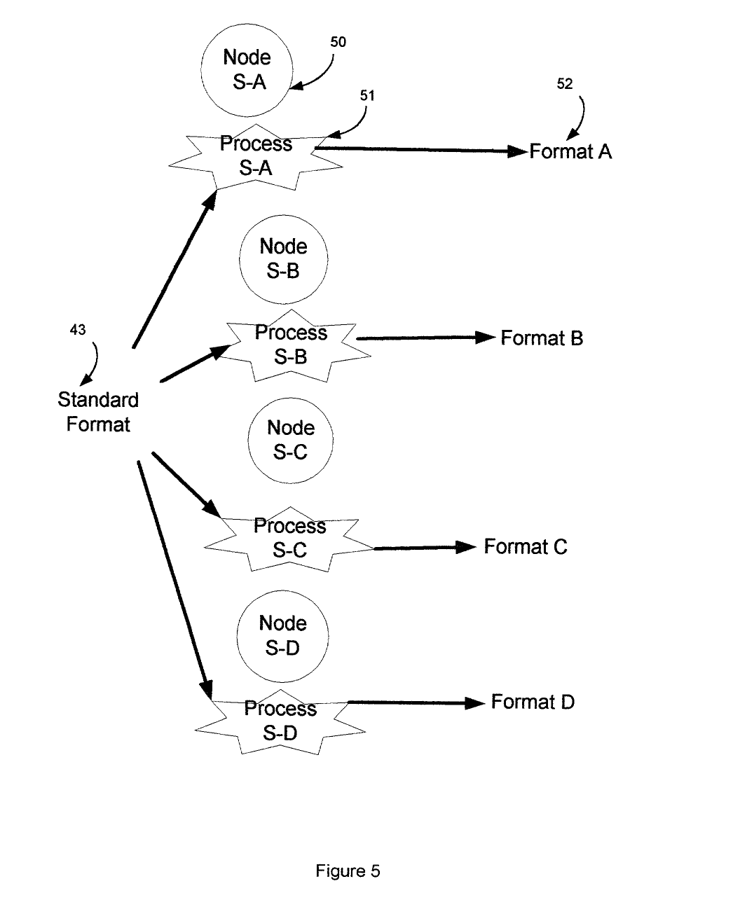

FIG. 4 illustrates the transformation of information from the incoming format into a standard format. In the example, Format A 42 is transformed into the standard format 43 by using transform A-S 41. Transform A-S 41 is associated with process node A-S 40 such that when process node 40 is part of a process description, a sequence of process nodes, transform A-S 41 is invoked at the appropriate point in the sequence to transform information in Format A 42 into the standard format 43. A transform is developed for each incoming information format and associated with a process node. For example, if an EMS private exchange owner has M OEM customers with M different BoM formats, M transforms are developed. Each transform is associated with a node and the node is associated with an OEM BoM format such that when an OEM transmits a BoM, the associated node is included in the process description so that the BoM is transformed into the standard format. FIG. 5 illustrates the transformation of information in the standard format into the format required for a trading partner. In the example, the standard format 43 is transformed to Format A 52 using transform S-A 51. Transform S-A 51 is associated with node 50 such that when process node 50 is part of a process description, transform S-A 51 is invoked at the appropriate point in the sequence to transform information in the standard format 43 into Format A 52. For example, if an EMS has N different ERP systems, each with a different BoM format, N transforms are developed. Each transform is associated with an EMS ERP system at an EMS site so that when a BoM is to be sent to the site the appropriate node is part of the process description so that the BoM is transformed into the format appropriate for the ERP system. The EMS will develop M+N translators rather than the M×N translators if each ERP system had to adapt to each customer. Not only are there fewer translators, the translators are managed and used in the private exchange rather than at each site. The translators may be better because of the focus that the private exchange provides.

The standard format for the EMS permits the EMS to provide a consistent, single interface to all of its trading partners and among its sites. Each site of the EMS has its own internal formats, part number set, systems, etc. However, in the Process and Transformation Private Exchange, the information: BoM, AML, CAD, etc. are in standard format. The EMS can have a global view of all of this information in a consistent format. Information can be aggregated, compared, etc. so that the EMS can take advantage of the sum of its sites. Information can be easily transferred from site to site. A new site can be added by connecting it to the Process and Transformation Private Exchange. A small number of transforms may needed to be developed. Many EMS, OEM, and suppliers are growing by acquisition. The Process and Transformation Private Exchange provides an easy means to integrate new sites.

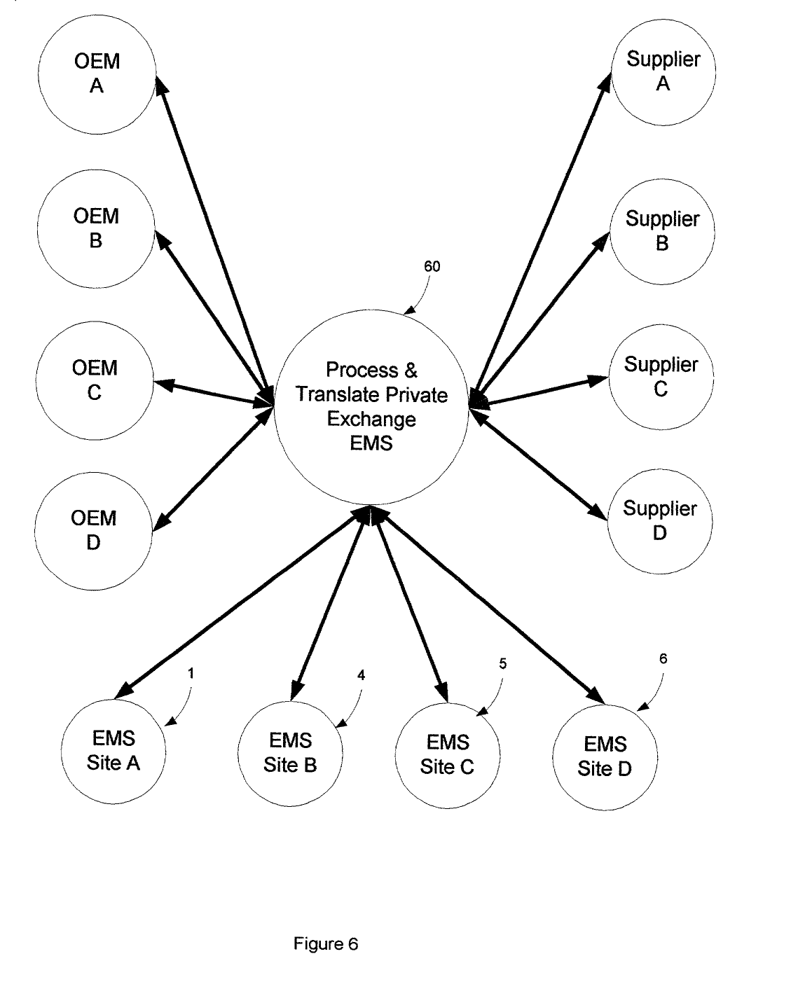

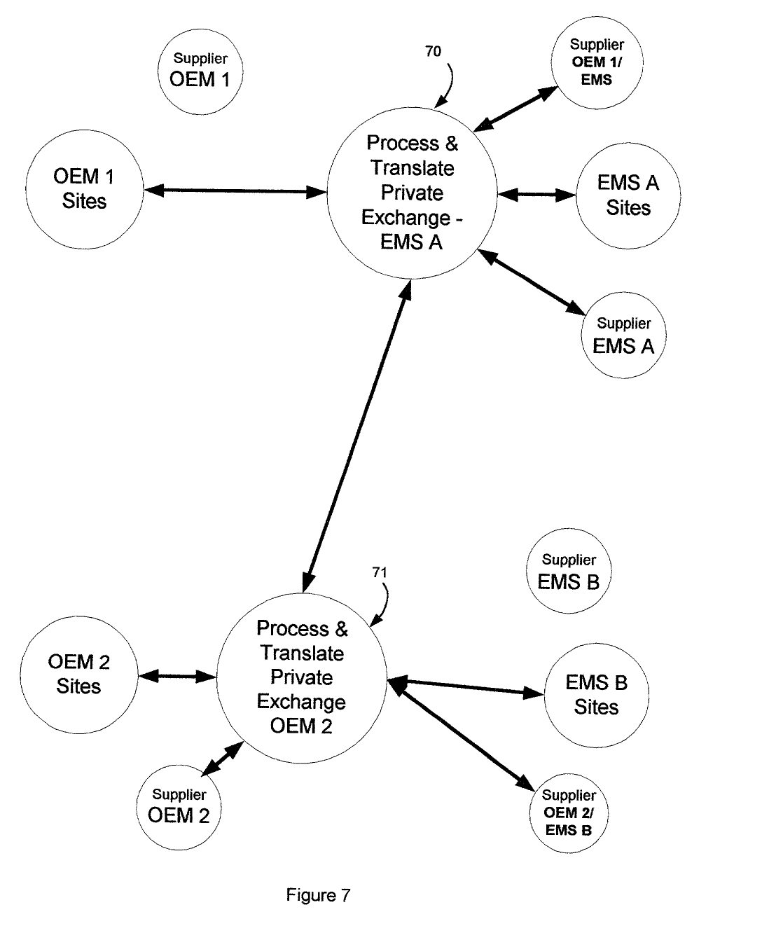

FIG. 6 illustrates the Process and Transformation Private Exchange 60, where the topology is the same as the Private Exchange 40 except the incoming information is transformed into a standard format and the out going information is transformed into the format required by the recipient. A new information sender is added with the development of an inbound transform. A new information recipient is added with the development of an outbound transform. The Process and Transformation Private Exchange is created for the benefit of the exchange owner. The standard format, validation and transformation processes are to enable the owner to be more effective in doing business. Connecting a trading partner requires the development of transforms and process descriptions for business processes that include the trading partner. FIG. 7 illustrates a Process and Transformation Private Exchange for EMS A 70. Connected are the sites of EMS A, the suppliers of EMS A, the sites of OEM 1, and the suppliers of OEM 1 that are suppliers of EMS A and the Process and Transformation Private Exchange of OEM 2 71. Note that a supplier of OEM 1 that is not a supplier of EMS A is not connected. The Process and Transformation Private Exchange for EMS A 70 is for the benefit of EMS A, its customers and suppliers that are direct trading partners. Process and Transformation Private Exchange for OEM 2 71 provides a single, consistent interface for the sites of OEM 2 to EMS A. Thus, the sites of OEM 2 do not need to connect to the Process and Transformation Private Exchange for EMS A 70 nor do the sites of EMS A need to connect to the Process and Transformation Private Exchange for OEM 2 71. A Process and Transformation Private Exchange may be connected with the development of transforms between the two internal standard formats.

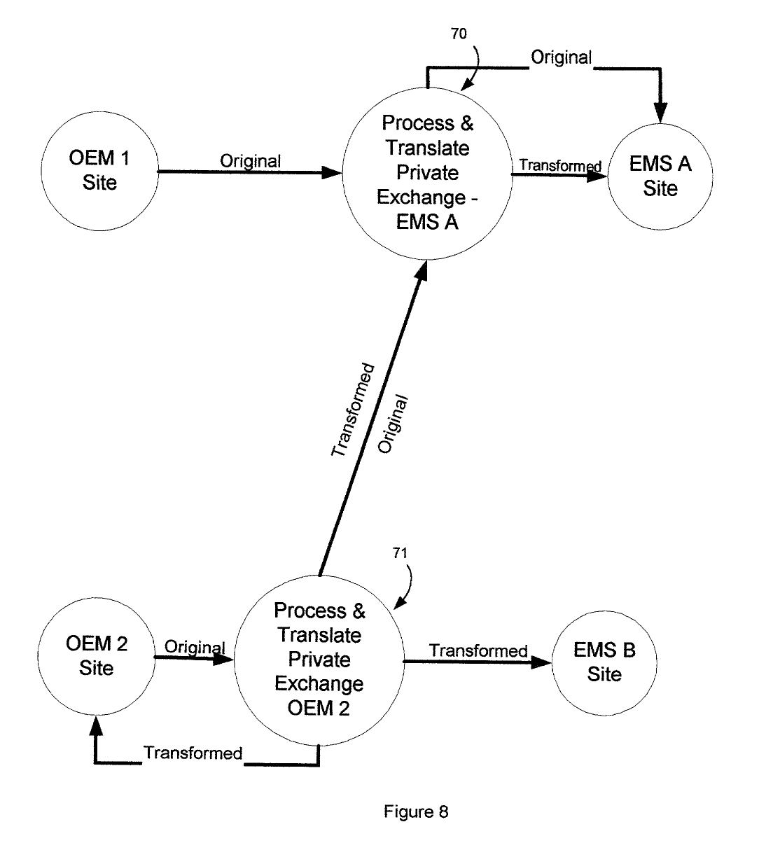

The Process and Transformation Private Exchange transforms information and the owner may want the standard format information, the transformed format information, or the original format information for records retention, back-up and recovery, audit trail, etc. As illustrated in FIG. 8, the Process and Transformation Private Exchange for EMS A 70 can provide the original format information and the transformed format information to the EMS A sites for a transaction from a site of OEM 1. The standard format information is also available. Process and Transformation Private Exchange for OEM 2 71 can provide the transformed format information for a transaction sent to EMS B so that OEM 2 can examine or save the information sent to EMS B. The Process and Transformation Private Exchange may provide the information in different formats so that the owner can keep the information. This may be of benefit if the Process and Transformation Private Exchange is provided as a hosted service and the owner wants to assure ownership of the information.

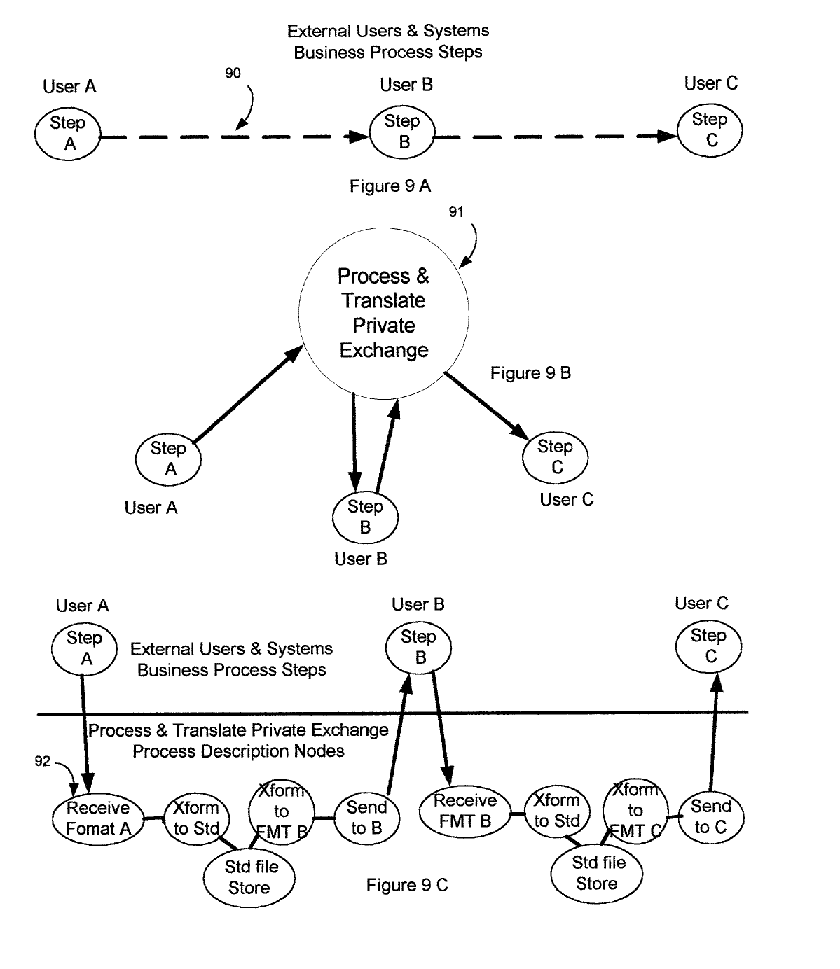

Most business processes are not a single transaction but a sequence of business process steps where a defined portion of the business process is completed at a step. A business process step may require information to be in a specific format for entry into a system and the resulting information in a format of the output of the system. FIG. 9A illustrates a three-step business process 90 where Step A initiates the process 90, which then goes to Step B, and then to Step C. Step A provides information in format A, Step B requires information in format B and returns information in Format B, and Step C requires information in format C. FIG. 9B illustrates the flow of information where Step A sends information to the Process and Transformation Private Exchange 91, which in turns sends information to Step B, returns the result that is then sent to Step C. The Process and Transformation Private Exchange 91 tracks the process steps and converts the information into the appropriate formats. FIG. 9C illustrates the process description 92 to accomplish this business process. The process description is a sequence of nodes. Process description 92 begins with receiving information in format A from User A at Step A, then transform information in format A to standard format, then store information in standard format, then transform information to format B, then send the information to User B at Step B, then receive the resultant information in format B, then transform information into standard format, the store the information in standard format, then transform the information to format C, and then send the information in format C to User C to perform Step C.

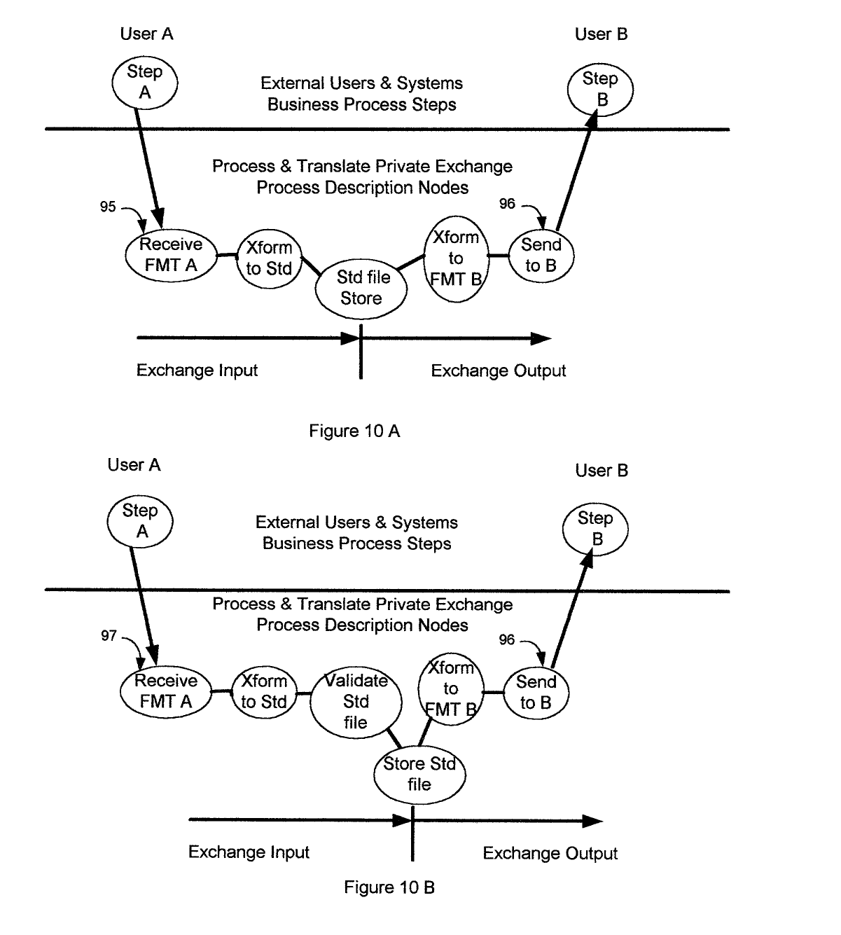

The process description is a workflow route, a sequence of workflow nodes where each node completes a specific task. The Process and Transformation Private Exchange is a workflow system that executes the workflow routes, the process descriptions where many of the business processes involve processing and transforming information. As a workflow system, the routes may have nodes that permit conditional branching so the process flow may be altered by decisions by users or by information content. A node may have two successor nodes so that parallel processes may be executed, a “fork” using parallel processing terminology. A node may have two predecessors so that parallel processes may “join” to a single process flow. A workflow system may track the execution of a route and identify the node which is active, trace the sequence of nodes executes, compute and display the time for the execution of a route, total time for route execution, average time for a set of route executions, etc. Workflow is a rich art and the process description as a route and the Process and Transformation Private Exchange as a workflow system captures all of this capability. The workflow capabilities may be used for measuring usage and used for billing purposes if the Process and Transformation Private Exchange is provided as a hosted service. The price may be a subscription model where the billing is based on a time period. For example, payments billed every month independent of usage. The Process and Transformation Private Exchange stores information and billing can be based on the volume of information stored. The workflow measurements and other measurements may be used to determine the value of the service provided by a Process and Transformation Private Exchange service and thus, establish the price for the service. The Process and Transformation Private Exchange can be thought of as two complementary systems: an Exchange Input and an Exchange Output. The Exchange Input is the process descriptions that operate on the information before its stored in standard format. The Exchange Output is the process descriptions that operate on the information after it is retrieved in standard format. In FIG. 10A, the Exchange Input process description 95 receives information in format A from User A, then transforms the information into standard format, then stores the information in standard format. The Exchange Output process description 96 retrieves the information in standard format, then transforms it into format B, then sends the information to User B. This separation permits one to think of business processes that input information as separate form the process that retrieve information rather than just transactions that flow through the Process and Transformation Private Exchange. For example, an EMS may have the OEM send all the BoM's for products for storage in the Process and Transformation Private Exchange and the EMS sites extract a BoM as needed.

It is not sufficient to just translate the information into the appropriate formats but also to validate the information before sending to the next process node. Validation is a very broad term and very dependent on the information and the use of the information. One example of validation for an EMS is checking that each item in a BoM has an item master, a record describing important characteristics of the item such as the description, the supplier, etc. The BoM in a standard format makes writing a validation program easier than writing a program for N formats at N sites or in M formats, one for each OEM customer. The validation of information is typically performed before storing the information and can be part of the Exchange Input. FIG. 10B illustrates the Exchange Input process description 97 where information is received from User A in format A, then transformed to standard format, then validated, and then stored. The information is retrieved by Exchange Output process description 96, the same process description in FIG. 10A, where the information is retrieved in standard format, then transformed to format B, then sent to User B.

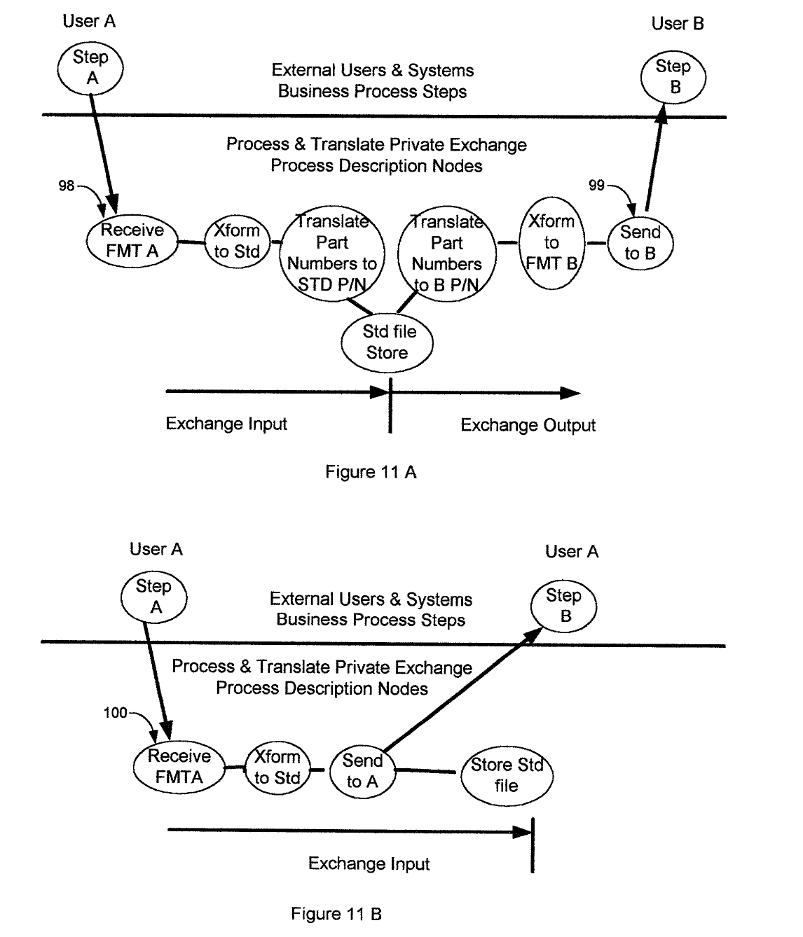

The product description information uses the item part numbers as key cross-reference information elements. Each organization has its own part number set that is usually different from the part number sets of their trading partners. Like information validation, part number transformation is an important business process and is most easily performed with the information in a standard format. FIG. 11A illustrates the Exchange Input with a process description 98 that receives information from User A in format A, the transforms the information to the standard format, then transforms the part numbers in the A part number set to the standard part number set, then stores the information. The Exchange Output with a process description 99 that retrieves the information from storage, transforms the part numbers in the standard part number set to the B part number set, then transforms the information into format B, then sends the information to User B.

As described earlier, the owner may want copies of the translated information for other purposes. FIG. 11B illustrates the Exchange Input process description 100 where information in format A is received from User A, then the information is transformed to standard format, then the information in standard format is sent to User A, and stored. The Exchange Input and Exchange Output can have process descriptions so that senders and recipients may receive copies of the original information as received, the information in standard format, and the information in the format sent.

### DESCRIPTION OF A PREFERRED EMBODIMENT

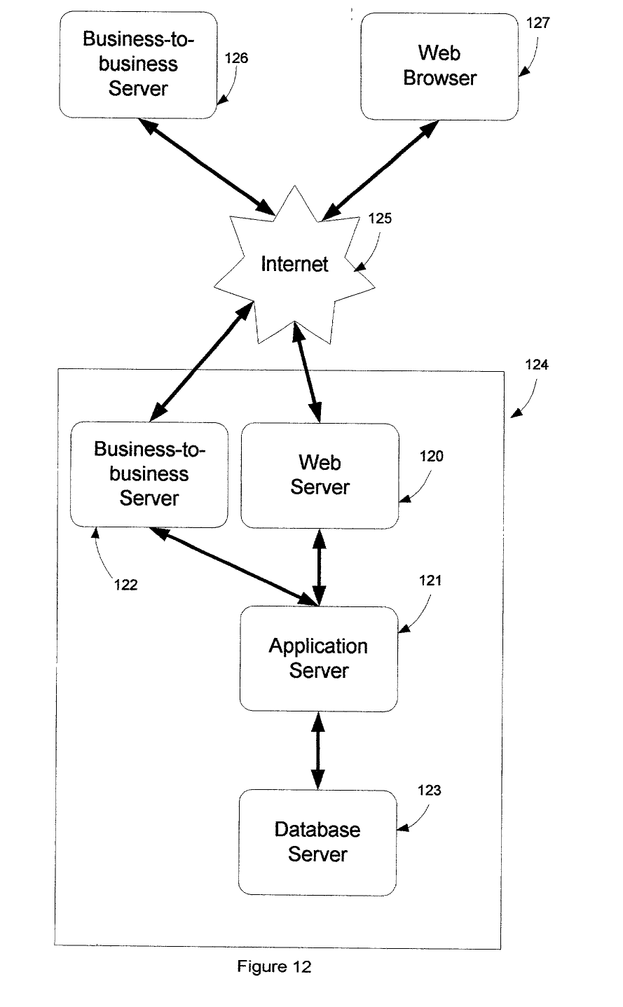

A Process and Transformation Private Exchange 124, illustrated in FIG. 12, consists of an Application Server 121, a Web Server 120, a Data Base Server 123, and a Business-to-business Server 122. These servers are software programs that execute on server hardware such as a PC from Dell or Compaq, a workstation or network server from SUN or Hewlett Packard, or a mainframe computer from IBM. The server hardware can have operating system services using for example, Microsoft Windows NT, Windows 2000, Sun Solaris, Hewlett Packard HP/UX, IBM O/S 9000, Lenix, etc. The Application Server program may be written in Java, C++, Visual Basic, or a variety of programming languages. Or, the program may be written to execute in an applet or Java bean server such as provided by BEA Web Logic Software or IBM Web Sphere or others. Microsoft Internet Integration Server, Netscape Web Server, or a variety of web server programs may provide the Web server program. Oracle9i Data Base, IBM DB2, Microsoft SQLServer, or other databases may provide the data base program. Extricity, Netfish, Vitria, are among a set of software providers of Business-to-business server programs. The Business-to-business server 122 may accept RosettaNet protocol, Internet File Transfer Protocol, EDI protocols, or a wide variety of public and private protocols. The Web server and the Business-to-business server connect to the Internet 125. Using the Internet, the Web Server connects to one or more Web clients 127 executing a Web browser, for example, Microsoft Internet Explorer or Netscape Navigator. The Web clients may be workstations, PC's, mainframe terminals, etc. However, a number of web clients are wireless devices such as: PDA's, cell phones, two way pagers, etc.

A program in the Application Server 121 provides the Process and Transformation Private Exchange functions and uses the Web Server 120 to connect to the Web clients 127, the Business-to-business Server 122 to connect to another Business-to-business Server 126, and the Database Server 123 to store all of the business and process information. The Application Server 121 may be written in conjunction with a workflow system such as the BEA Web Logic Process Integrator or the Extricity workflow product. The BEA Web Logic Process Integrator is written in Java beans and runs on the BEA Web Logic Java bean server and is ideal for developing the program that provides the Process and Transformation Private Exchange functions. The process definitions can be written as workflow routes and the tools for route generation used for process definition development. The workflow functions may be used for reporting usage, active process definitions and active nodes, process definition execution time, etc. The process definitions are kept in the workflow route library and invoked as active instances when the information is sent to the Process and Transformation Private Exchange or information is requested. Information transfer may be through the Web client 127 or through the Business-to-business Sever 122. The transformation programs are stored in a program library in the Database Server 123 where the transformation programs are associated with workflow nodes and invoked when the workflow node executes. The information in the form of files is stored in the Database Server 123.

A set of information, a file, is sent by a user at a Web client 127 or from a system through the Business-to-business Server 122. The file from the Web client passes through the Web server 120 to the Application Server 121. A file from the Business-to-business Server 122 transfers directly to the Application Server 121. The Application Server 121 associates the file with a process definition based on the sender's identification. The Application Server 121 accesses the selected process definition and begins execution of the initial node. The node specifies the transformation or process program to operate on the file. If the node specifies storing the file, the file is stored in the Database Server 123. If the process definition specifies another transformation of the file, the Application Server 121 selects the specified transformation program to operate on the file. If specified by the process definition, the transformed file is sent to the specified user or system. If it is to be sent to a user, the Web Server 120 and Web Client 127 are used. If it is to be sent to a system, the Business-to-business 123 is used.

I claim:

1. An Exchange Input, a first sender, a first recipient, all connected to a network, where the Exchange Input consists of means to send and to receive a file using the network; a process description, a sequence of process nodes; and means for file transformation from a first file format to a standard file format; and means to store a file in standard format in a data storage medium, wherein the process description includes a first process node for the receipt of a file in the first format from a first sender, a second process node for transforming the file to the standard file format, a third process node for the storage of the transformed file in standard format such that the Exchange Input receives a file in the first format from the first sender, transforms the file to the standard format, and stores the transformed file in the standard format.

2. The Exchange Input of claim 1, wherein the process description further includes a process node for validating the file in standard format such that the Exchange Input validates the file in standard format before storing the transformed file in standard format.

3. The Exchange Input of claim 1, wherein the process description further includes a process node for translating a file using a first part number set to a file using a standard part number set such that the Exchange Input translates a file using the first part number to a file using the standard part number set.

4. The Exchange Input of claim 1, wherein the process description further includes a process node for sending the file in the first format to the first recipient such that the Exchange Input receives a file in the first format from the first sender and sends the file in the first format to the first recipient.

5. The Exchange Input of claim 1 wherein the process description further includes a process node for sending the file in the standard format to the first sender such that Exchange Input receives a file in the first format from the first sender and sends the transformed file in the standard format to the first sender.

6. The Exchange Input of claim 1 wherein the process description further includes a process node for sending the file in the standard format to the first recipient such that the Exchange Input receives a file in the first format from the first sender and sends the transformed file in the standard format to the first recipient

7. An Exchange Output, a first sender, a first recipient, all connected to a network, where the Exchange Output consists of means to send and to receive a file using the network; a process description, a sequence of process nodes; and means for file transformation from a standard file format to a second file format; and means to retrieve a file stored in standard format in a data storage medium, wherein the process description includes a first process node for retrieving a file stored in standard format, a second process node for transforming the file in standard format to the second file format, a third process node for sending of the transformed file in the second format to the first recipient such that the Exchange Output retrieves a file in standard format, transforms the file to the second format, and sends the transformed file in the second format to the first recipient.

8. The Exchange Output of claim 7, wherein the process description further includes a process node for validating the file in standard format such that the Exchange Output validates the file in standard format before transforming the file to the second format.

9. The Exchange Output of claim 7, wherein the process description further includes a process node for translating a file using a standard part number set to a file using a second part number set such that the Exchange Output translates a file using the standard part number set to file using the second part number set.

10. The Exchange Output of claim 7 wherein the process description further includes a process node for sending the file in the standard format to the first recipient such that the Exchange Output sends the retrieved file in the standard format to the first recipient

11. The Exchange Output of claim 7 wherein the process description further includes a process node for sending the file in the second format to the first sender such that the Exchange Output sends the retrieved file in the second format to the first sender

12. A Process and Transformation Private Exchange consisting of an Exchange Input and an Exchange Output where the files stored in the data storage medium by the Exchange Input may be retrieved by the Exchange Output.

13. The Process and Transformation Private Exchange of claim 12 wherein the process description is a workflow route and the Process and Transformation Private Exchange is a workflow system.

14. The Process and Transformation Private Exchange of claim 12 further consists of a means for tracking the execution of each process node in a process description and a means for reporting the current node in the execution of a process description.

15. The Process and Transformation Private Exchange of claim 12 further consists of a means for pricing the use of the Process and Transformation Private Exchange based on usage.

16. The Process and Transformation Private Exchange of claim 12 further consists a means for pricing the use of the Process and Transformation Private Exchange based on a subscription for a period of time.

17. The Process and Transformation Private Exchange of claim 12 further consists of a means for pricing the use of the Process and Transformation Private exchange based on the volume of files stored in the data storage medium.

18. The Process and Transformation Private Exchange of claim 12 where the network is connected to the Internet.

19. The Process and Transformation Private Exchange of claim 12 further consists of a means for storing an audit trail of the processes descriptions and process nodes executed.
